(19) United States
(12) Patent Application Publication
(10) Pub. No.: US 2014/0000400 A1
(43) Pub. Date: Jan. 2, 2014

(54) ACTUATOR

(71) Applicant: Milan Klimes, Niles, MI (US)

(72) Inventor: Milan Klimes, Niles, MI (US)

(21) Appl. No.: 13/830,261

(22) Filed: Mar. 14, 2013

Related U.S. Application Data
(60) Provisional application No. 61/665,978, filed on Jun. 29, 2012.

(51) Int. Cl. F16H 1/20

(52) U.S. Cl. CPC F16H 1/20
USPC 74/421 A

(57) ABSTRACT

An actuator comprising a housing defining an interior cavity for a motor assembly including a rotatable motor pinion and a stator, a gear assembly including a plurality of rotatable gears, and a sensor assembly including a substrate. The motor pinion includes a yoke, a motor magnet surrounding the yoke, and a sensor magnet. In one embodiment, the second gear is located between and coupled to both the motor pinion and the first gear. Each of the motor pinion and the plurality of gears is mounted for rotation on respective shafts. In one embodiment, each of the shafts includes a stop that limits the axial travel of the motor pinion and the plurality of gears. The motor pinion and the plurality of gears are positioned in the housing in a longitudinal, co-linear, and side-by-side coupling and meshed relationship.

### CROSS-REFERENCE TO RELATED APPLICATIONS

This application claims the benefit of the filing date and disclosure of U.S. Provisional Application Ser. No. 61/665,978, filed on Jun. 29, 2012 which is explicitly incorporated herein by reference as are all references cited therein.

### FIELD OF THE INVENTION

The present invention relates to actuators in general and, in particular, to a rotary actuator.

### BACKGROUND OF THE INVENTION

This invention relates to an actuator which can be used in a wide variety of applications to control the rotary motion of an apparatus or part including, for example, valves, switches, and indicators. An actuator of the type forming the subject of this invention includes three main components: an electric motor assembly including a rotor and a stator; a gear assembly which couples the rotor of the motor to the rotatable shaft of the apparatus or part; and a sensor and control assembly.

The present invention addresses the continued need for an actuator with a reduced number of component parts and of reduced cost.

### SUMMARY OF THE INVENTION

The present invention is directed to an actuator comprising a housing; a motor assembly in the housing which includes a rotatable motor pinion and a stator surrounding and spaced from the motor pinion; a gear assembly in the housing which includes a first rotatable gear coupled to the motor pinion and a second rotatable gear adapted for rotation in response to the rotation of the motor pinion and the first rotatable gear; the motor pinion and the first and second gears being positioned in a generally horizontally co-linear and side-by-side relationship; and a sensor assembly which includes a substrate in the housing.

In one embodiment, the motor pinion includes a collar with gear teeth, and each of the first and second gears includes a gear wheel with gear teeth and a collar with gear teeth, the gear teeth on the collar of the motor pinion being coupled to the gear teeth on the gear wheel of the first gear, and the gear teeth on the collar of the first gear being coupled to the gear teeth on the gear wheel of the second gear.

In one embodiment, the motor pinion is mounted for rotation on a motor pinion shaft and each of the first and the second gears is mounted for rotation on first and second gear shafts respectively, the motor pinion gear shaft and the second gear shaft including an end with a radial flange defining an axial end stop for the motor pinion and the second gear respectively.

In one embodiment, the first gear shaft includes a lower end with a radial flange which is secured in a base of the housing and an upper end which includes a washer and a retaining ring coupled thereto for retaining the first gear on the first gear shaft and defining an axial end stop for the first gear.

In one embodiment, the substrate is suspended in the housing between the stator of the motor assembly and a cover of the housing.

In one embodiment, the motor pinion includes a motor magnet, a sensor magnet, and a yoke.

In one embodiment, the motor pinion includes a base, the yoke surrounding the base, the motor magnet surrounding the yoke, and the sensor magnet is located above the yoke and the motor magnet.

In one embodiment, the gear assembly includes a third rotatable gear coupled between the first and second gears.

In one embodiment, the motor pinion includes a collar with gear teeth, and each of the first, second, and third gears includes a gear wheel with gear teeth and a collar with gear teeth, the gear teeth on the collar of the motor pinion being coupled to the gear teeth on the gear wheel of the first gear, the gear teeth on the collar of the first gear being coupled to the gear teeth on the gear wheel of the third gear, and the gear teeth on the collar of the third gear being coupled to the gear teeth on the gear wheel of the second gear.

In one embodiment, the motor pinion is mounted for rotation on a motor pinion shaft and each of the first, second, and third gears is mounted for rotation on first, second, and third gear shafts respectively.

The present invention is also directed to an actuator comprising a housing; a motor assembly which includes a rotatable motor pinion and a stator located and mounted in the housing, the motor pinion including a base, a yoke surrounding the base, a motor magnet surrounding the yoke, and a sensor magnet located above the base; a gear assembly in the housing which includes a plurality of gears adapted for rotation in response to the rotation of the motor pinion; a sensor assembly which includes a substrate suspended in the housing in a relationship spaced and opposed to the sensor magnet on the motor pinion of the motor assembly.

In one embodiment, the motor magnet and the sensor magnet are ring-shaped and the yoke is in the form of a tube.

In one embodiment, the yoke includes a flange and the sensor magnet is seated on the flange of the yoke.

In one embodiment, the motor pinion and the plurality of gears are located in the housing in a longitudinal, co-linear, and side-by-side relationship.

The present invention is further directed to an actuator comprising: a housing which includes a base defining an interior cavity and a cover; a motor assembly which includes a rotatable motor pinion located and mounted in the cavity in the base of the housing; a gear assembly which includes first and second gears located and mounted in the cavity in the base of the housing, the first gear being coupled to the motor pinion for rotation therewith and the second gear being coupled to the first gear for rotation therewith; first, second, and third shafts located and mounted in the cavity in the base of the housing, the first and second gears and the motor pinion being mounted for rotation on the first, second, and third shafts respectively, the first and third shafts each including a stop that limits the axial travel of the motor pinion and the first and second gears respectively in the direction of the base of the housing, the first shaft including a stop that limits the axial travel of the motor pinion and the first and second gears in the direction of the cover; and a sensor assembly including a substrate located in the cavity in the base of the housing.

In one embodiment, the motor pinion and the first gear each include a shoulder and the first and second gears each include a gear wheel, the gear wheel on the second gear abutting against the shoulder on the first gear and the gear wheel on the first gear abutting against the shoulder on the motor pinion.

In one embodiment, the stop on each of the first and third shafts is a radial flange on a lower end of the first and third shafts respectively and the stop on the first shaft includes a washer and a retaining ring on an upper end of the first shaft.

There are other advantages and features of this invention which will be more readily apparent from the following detailed description of the embodiment of the invention, the drawings, and the appended claims.

### BRIEF DESCRIPTION OF THE DRAWINGS

In the accompanying drawings that form part of the specification, and in which like numerals are employed to designate like parts throughout the same:

FIG. 1 is a perspective view of an actuator in accordance with the present invention;

FIG. 2 is a top plan view of the actuator shown in FIG. 1 with the cover removed;

FIG. 3 is a vertical cross-sectional view of the actuator shown in FIG. 1;

FIG. 4 is a perspective view of the motor pinion of the motor assembly of the actuator shown in FIG. 1;

FIG. 5 is a vertical cross-sectional view of the motor pinion shown in FIG. 3;

FIG. 6 is a perspective view of the sensor magnet of the motor pinion shown in FIGS. 4 and 5.

FIG. 7 is a perspective view of the motor magnet of the motor pinion shown in FIGS. 4 and 5; and

FIG. 8 is a perspective view of the yoke of the motor pinion shown in FIGS. 4 and 5;

FIG. 9 is a perspective view of another embodiment of an actuator in accordance with the present invention;

FIG. 10 is a top plan view of the actuator shown in FIG. 9 with the cover removed; and

FIG. 11 is a vertical cross-sectional view of the actuator shown in FIG. 9.

### DETAILED DESCRIPTION OF THE EMBODIMENTS

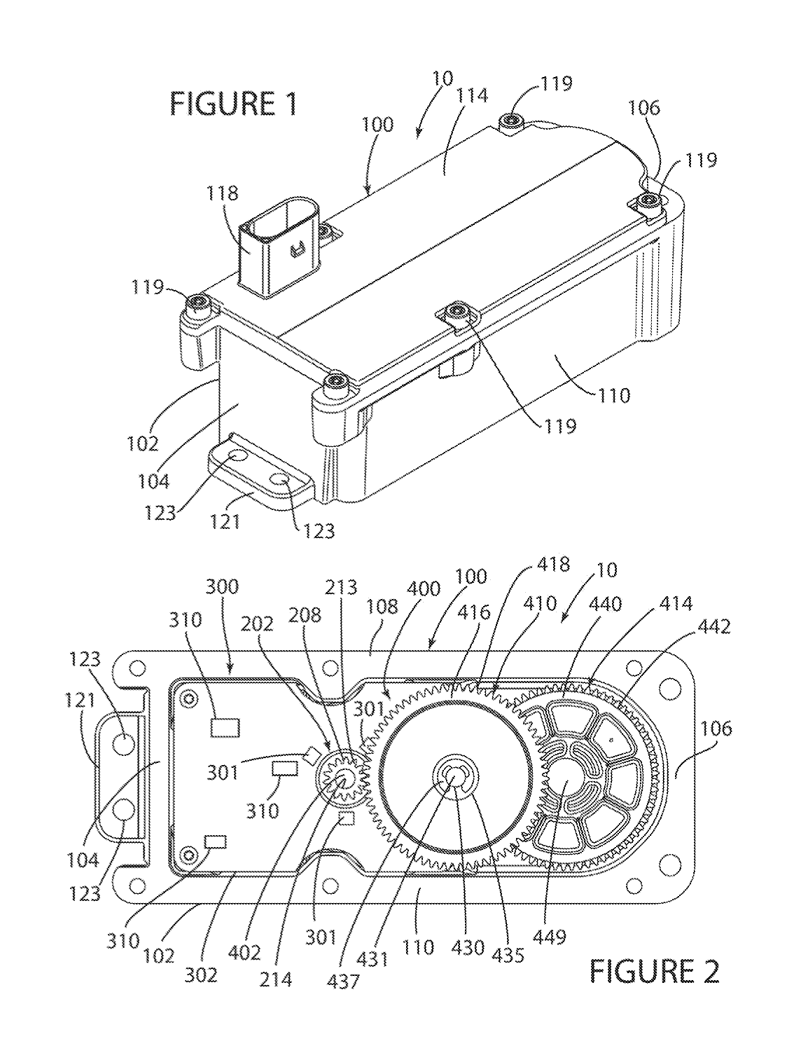

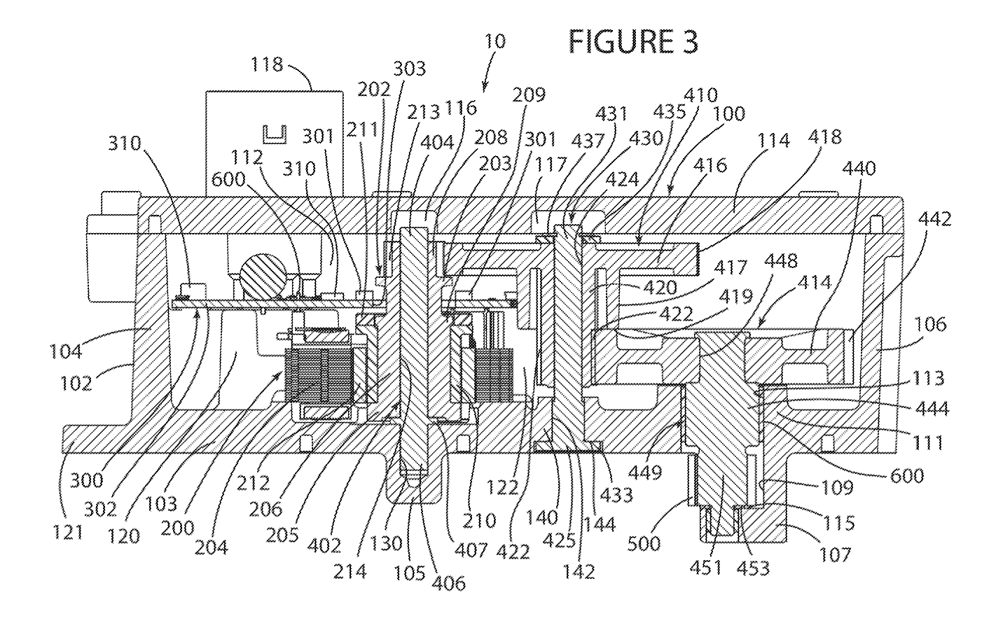

FIGS. 1, 2, and 3 depict a rotary actuator 10 in accordance with the present invention which comprises a housing 100 having a motor assembly 200 (FIG. 3), a circuit board and sensor control assembly 300 (FIGS. 2 and 3), and a gear assembly 400 (FIGS. 2 and 3) located and mounted in the housing 100.

The actuator 10 can be used in a wide variety of applications to control the rotary motion of an apparatus or part coupled thereto including, for example, to control the rotary motion of the shaft (not shown) of a vehicle turbocharger assembly (not shown).

The housing 100, which in the embodiment shown is generally rectangularly-shaped, includes an elongate generally rectangularly-shaped metal base 102 with an elongate bottom horizontal plate or floor 103 (FIG. 3), a pair of longitudinally extending and opposed side walls 108 and 110 (FIGS. 1 and 2), and a pair of transversely extending and opposed side walls 104 and 106, all extending unitarily generally normally upwardly from the top peripheral interior edge of the floor 103 and together with the floor 103 defining an interior basin or cavity 112 (FIG. 3) which houses the motor assembly 200, the circuit board and control assembly 300, and the gear assembly 400 of the actuator 10 as described in more detail below.

A mounting bracket 121 (FIGS. 1 and 2) protrudes generally normally outwardly from a lower edge of the side wall 104 of the base 102 of the housing 100 and defines a pair of through-holes 123 adapted to receive screws (not shown) for mounting the actuator 10 to the vehicle.

The housing 100 still further includes an elongate and generally rectangularly-shaped removable plate or cover 114 (FIGS. 1 and 3) which: may be made of plastic or the like material; is seated over the top peripheral edge of the housing walls 104, 106, 108, and 110 of the base 102; and covers the cavity 112 in the base 102 of the housing 100. A plurality of spaced-apart screws 119 (FIG. 1) extend through the peripheral edge of the cover 114 and into the peripheral edge of the housing walls 104, 106, 108, and 110 for securing the cover 114 to the base 102 of the housing 100.

As shown in FIG. 1, the cover 114 includes an interior surface defining a pair of generally cylindrically-shaped interior apertures or cavities 116 and 117 (FIG. 3) adapted to receive the upper end 404 of the motor shaft 402 of the motor assembly 200 and the upper end 431 of the gear shaft 430 respectively as described in more detail below.

As further shown in FIGS. 1 and 3, the cover 114 also includes an electrical terminal connector assembly 118 extending unitarily outwardly from the outer surface of the cover 114.

The base 102 of the housing 100 includes a pair of spaced-apart and generally parallel interior printed circuit board/substrate mounting posts or flanges or pedestals 120 and 122 (FIG. 3) extending generally normally upwardly and outwardly from the floor 103 of the base 102 into the interior of the cavity 112 of the base 102 and in the direction of the cover 114.

The floor 103 of the base 102 of the housing 100 includes a motor shaft sleeve or collar 105 (FIG. 3) extending generally normally outwardly from the exterior surface of the floor 103 and defining an interior recess or cavity 130 (FIG. 3) adapted to receive a lower end 406 of the motor shaft 402 as described in more detail below.

The floor 103 of the base 102 of the housing 100 further includes an elongate, partially open output shaft sleeve or collar 107 (FIG. 3) extending generally normally outwardly from the exterior surface of the floor 103 of the base 102 of the housing 100 and defining an interior recess or cavity 109 (FIG. 3) adapted to receive the lower end 451 of an output gear shaft 449 as described in more detail below.

In the embodiment shown, the output gear shaft sleeve or collar 107 is located in the floor 103 of the base 102 adjacent and spaced from the transverse side wall 106 of the base 102 of the housing 100. Also, in the embodiment shown, the output shaft sleeve or collar 107 defines a seat or shoulder 115. The motor shaft sleeve or collar 105 is located in the floor 103 of the base 102 of the housing 100 between the transverse side wall 104 and the output gear shaft sleeve or collar 107.

The floor 103 of the base 102 of the housing 100 further includes another output gear sleeve or collar 111 (FIG. 3) extending generally normally outwardly from the interior surface of the floor 103 and defining an interior recess or cavity 113 (FIG. 3) adapted to receive the collar 444 (FIG. 3) of the output gear shaft 449 as described in more detail below. The sleeve or collar 111 is co-axial with the sleeve or collar 107.

The floor 103 of the base 102 of the housing 100 includes yet another sleeve or collar 140 (FIG. 3) extending generally normally inwardly from the interior surface of the floor 103 of the base 102 of the housing 100 and defines another interior recess or cavity 142 (FIG. 3) defining an interior shoulder 144 (FIG. 3) and adapted to receive the lower end 425 of an intermediate gear shaft 430 (FIG. 3) as also described in more detail below.

In the embodiment shown, the sleeve or collar 140 is located in the floor 103 of the base 102 of the housing 100 in a relationship spaced from and between the respective sleeves or collars 105 and 107 also in the floor 103 of the base 102 of the housing 100.

The actuator 10 further comprises the motor assembly 200 (FIG. 3) that includes a rotor in the form of a rotatable motor pinion 202 and a stationary stator assembly 204.

The motor pinion 202, as shown in more detail in FIGS. 3, 4, 5, 6, 7, and 8, is preferably made of a plastic or the like material and, in the embodiment shown, includes a generally cylindrical base 206 (FIGS. 3 and 5), a circumferentially extending bottom plate or flange 205 (FIGS. 3 and 5) protruding unitarily generally normally outwardly from a lower edge of the base 206, and an elongate collar 208 (FIGS. 3, 4, and 5) extending unitarily outwardly and upwardly from the base 206.

In the embodiment shown, the base 206 has a diameter greater than the diameter of the collar 208 and thus a shoulder or flange 209 projecting unitarily generally normally outwardly from the exterior surface of the base 206 is defined on the motor pinion 202. Another circumferentially extending flange 203 (FIGS. 3, 4, and 5) protrudes unitarily generally normally outwardly from the exterior surface of the collar 208 in a relationship spaced from and parallel to the shoulder or flange 209.

The motor pinion 202 also includes a yoke 210 that is made of metal, is in the shape of a cylinder or tube open at both ends (FIGS. 3, 4, and 5), surrounds and is abutted against the exterior surface of the base 206 of the motor pinion 202, includes a lower end seated and abutted against the top of the flange 205, and includes an upper circumferentially extending and outwardly protruding unitary flange 221 with an exterior surface that is abutted against a lower surface of the shoulder 209 on the motor pinion 202.

A motor magnet 212 (FIGS. 3, 4, 5, and 6) in the form or shape of a ring surrounds and is abutted against the exterior surface of the yoke 210 on the motor pinion 202.

A sensor magnet 211 (FIGS. 3, 4, 5, and 7) in the form or shape of a ring surrounds the shoulder 209 of the motor pinion 202 and is seated against the top exterior surface of the flange 221 of the yoke 210. In the embodiment shown, the ring-shaped motor magnet 212 has a width greater than the ring-shaped sensor magnet 211.

The exterior surface of the collar 208 includes a plurality of vertically oriented gear teeth 213 (FIGS. 3, 4, and 5) formed thereon and a central through-aperture 214 (FIGS. 3 and 5) extends through the center of the base 206 and the collar 208.

Referring back to FIGS. 2 and 3, an elongate stationary motor shaft 402 is located and mounted in the cavity 112 of the base 102 of the housing 100 in a generally vertical and normal relationship relative to the floor 103 of the base 102 and the cover 114 of the housing 100 wherein a first upper end 404 of the motor shaft 402 extends into the aperture 116 defined in the interior surface of the cover 114 of the housing 100 and a lower end 406 of the motor shaft 402 is secured in the recess 130 defined in the sleeve 107 in the floor 103 of the base 102 of the housing 100.

As shown in FIG. 3, the lower end 406 of the motor shaft 402 includes a horizontal outwardly projecting radial flange 407 that extends generally normally outwardly from the exterior surface thereof and is seated and abutted against the exterior surface of the floor 103 of the base 102 of the housing 100 and defines an axial end stop that abuts against the lower surface of the base 206 of the motor pinion 202 and limits the travel of the motor pinion 202 in the direction of the floor 103 of the base 102 of the housing 100.

As shown in FIG. 3, the motor pinion 202 is located in the cavity 112 in the base 102 of the housing 100 in a relationship surrounding and rotatable relative to the motor shaft 402 and in a relationship wherein the lower surface of the base 206 of the motor pinion 202 is abutted and seated against the upper surface of the radial flange 407 on the motor shaft 402. In the embodiment shown, the motor shaft 402 and the collar 208 of the motor pinion 202 extend through an opening 303 in the substrate 302.

The motor assembly 200 further includes a stationary stator assembly 204 (FIG. 3) which is also located and mounted in the cavity 112 in the base 102 of the housing 100 in a relationship surrounding and spaced from the motor pinion 202.

The actuator 10 still further comprises a circuit board and control assembly 300 (FIGS. 2 and 3) that includes a plurality of elements including, for example, a plurality of magnetic field sensors 301 such as Hall effect sensors, a processor or controller, and other passive and active electronic components 310 mounted on one or both sides of a generally flat printed circuit board or substrate 302 that is located and mounted in the cavity 112 in the base 102 of the housing 100 in a horizontal relationship and that is seated against the top surface of the interior mounting posts or pedestals 120 and 122.

Thus, in the embodiment shown, the printed circuit board or substrate 302 is located in the cavity 112 in the base 102 of the housing 100 in a suspended horizontal and parallel relationship between and spaced from the floor 103 of the base 102 and the cover 114 and, more specifically, is located between the stator assembly 204 and the cover 114. Further, in the embodiment shown, the printed circuit board or substrate 302 is located in the cavity 112 in the base 102 of the housing 100 between the transverse side wall 104 of the base 102 of the housing 100 and the motor pinion 202.

In the embodiment shown, the base 206 of the motor pinion 202 is located below the substrate 302 and the top surface of the ring shaped sensor magnet 211 on the motor pinion 202 is located below and spaced from and generally opposite and parallel to the Hall effect sensors 301 and the substrate 302. Further, in the embodiment as shown in FIGS. 2 and 3, the substrate 302 includes three Hall effect sensors 301 mounted on the top surface of the substrate 302 and extending circumferentially around the opening 303 defined in the substrate 302 in a spaced apart relationship and thus the three Hall effect sensors 301 are positioned in a relationship surrounding the motor pinion shaft 402 and the collar 208 of the motor pinion 202 extending through the opening 303. In the embodiment shown, the three sensors 301 are located and spaced around the through-aperture 303 one hundred and twenty degrees from each other.

A plurality of stator terminals, only one such terminal 600 being shown in FIG. 1, extend from the stator assembly 204 and upwardly into and through the substrate 302 while connector terminals (not shown) extend downwardly into the end of the substrate 302 for electrically interconnecting together the motor assembly 200, the substrate 302, and the connector assembly 118.

As shown in FIGS. 2 and 3, the gear assembly 400 of the actuator 10 includes a rotatable intermediate first gear 410 and a rotatable output second gear 414 which are both located and mounted in the cavity 112 in the base 102 of the housing 100 and are coupled to each other and to the motor pinion 202 for rotation as described in more detail below.

The intermediate gear 410 is preferably made of plastic or the like material and includes a gear wheel 416 with peripheral and circumferentially extending gear teeth 418 formed thereon and an elongate rotatable collar 420 (FIG. 1) extending unitarily downwardly and normally outwardly and centrally from the lower surface of the gear wheel 416 and including an outer surface with a plurality of gear teeth 422 (FIG. 3) formed thereon. Additionally, and as shown in FIG. 3, a circumferential wall 417 defining a terminal circumferential end abutment shoulder 419 protrudes and extends outwardly from the lower surface of the gear wheel 416 in a relationship spaced from the collar 420. In the embodiment shown, the gear wheel 416 is located in the housing 100 in a relationship spaced, parallel and above the substrate 302.

The intermediate gear 410 additionally defines a through-aperture 424 (FIG. 3) extending centrally through the interior of the collar 420 and the gear wheel 416.

The gear assembly 400 also includes an elongate stationary gear I-shaft 430 (FIGS. 2 and 3) extending through the intermediate gear 410 and, more specifically, through the central through-aperture 424 defined therein in a relationship normal to the floor 103 and the cover 114 of the housing 100.

The I-shaft 430 includes a lower end 425 (FIG. 3) and an upper end 431. The lower end 425 includes a horizontal radial flange 433 (FIG. 3) extending generally normally outwardly from the exterior surface thereof. A washer 435 surrounds the upper end 431 of the I-shaft 430 and is seated against the top surface of the gear wheel 416 of the intermediate gear 410. A retaining ring 437 also surrounds the upper end 431 of the I-shaft 430 and is seated against the top surface of the washer 435.

The intermediate gear 410 and the I-shaft 430 are located and mounted in the cavity 112 in the base 102 of the housing 100 in a relationship wherein the upper end 431 of the I-shaft 430 extends into the recess 117 in the cover 114 of the housing 100; the lower end 425 of the I-shaft 430 is received and secured in the recess 142 defined in the floor 103 of the base 102 of the housing 100 and, more specifically, in a relationship wherein the radial flange 433 on the lower end 425 of the I-shaft 430 is abutted against the shoulder 144 defined in the floor 103 of the base 102 of the housing 100; the washer 435 holds the intermediate gear 410 on the gear I-shaft 430; the retaining ring 437 retains the washer 435 and the gear 410 on the gear I-shaft 430 and defines an axial end stop that limits the axial travel of the gear 410 in the direction of the cover 114; the gear 410 is rotatable relative to the I-shaft 430; the gear wheel 416 of the intermediate gear 410 is positioned in a relationship opposed, spaced from, and generally parallel to the cover 114 of the housing 100; and the gear teeth 418 on the gear wheel 416 are disposed in a relationship coupled and meshed to the gear teeth 213 on the collar 208 of the motor pinion 202 of the motor assembly 200 and further in a relationship abutted against the top of the shoulder 203 on the motor pinion 202 and thus also defining an axial end stop that limits the axial travel of the gear 410 in the direction of the plate 103 of the base 102 of the housing 100.

The output gear 414, which is also preferably made of plastic or the like material, is similar in structure to the intermediate gear 410 and includes a rotatable gear wheel 440 (FIGS. 2 and 3) with peripheral and circumferentially extending gear teeth 442 formed thereon and a separate elongate rotatable gear shaft 449 (FIGS. 2 and 3) extending downwardly and normally outwardly and centrally from the bottom surface of the gear wheel 440 in a relationship normal to the floor 103 of the housing 100 and including an upper end extending through a central through-hole 448 (FIG. 3) defined in the gear wheel 440. In the embodiment shown, the gear wheel 440 is located in the housing 100 in a spaced and parallel relationship between both the gear wheel 416 and the substrate 302.

The output gear shaft 449 includes a lower end 451 (FIG. 3) defining a horizontal radial shoulder 453 (FIG. 3) defining an axial end stop.

The output gear 414 and the output gear shaft 449 are located and mounted in the housing 100 in a relationship wherein: the collar 444 of the output gear shaft 449 extends through the sleeves 111 and 107 in the floor 103 of the base 102 of the housing 100; the lower end 451 of the output gear shaft 449 is received in the recess 109 defined in the sleeve 107 in the floor 103 of the base 102 of the housing 100 and the radial shoulder 453 on the lower end 451 of the output gear shaft 449 is seated against the top of the sleeve shoulder 115 and defines an axial end stop for the output gear 414 that limits the axial travel of the output gear 414 in the direction of the floor 103 of the base 102; the output gear 414 is rotatable relative to the output gear shaft 449; the gear wheel 440 is positioned in a relationship opposed, spaced from, below, and generally parallel to, the gear wheel 440 of the intermediate gear 410; and the gear teeth 442 on the gear wheel 416 are disposed in a relationship coupled and meshed to the gear teeth 422 on the collar 420 of the intermediate gear 410 and in a relationship abutting against the shoulder 419 on the wall 417 of the intermediate gear 410 to define another axial end stop that also limits the axial travel of the intermediate gear 410 in the direction of the floor 103 of the base 104 of the housing 100.

Thus, in the embodiment shown, the output gear 414 is located and mounted in the cavity 112 in the base 102 of the housing 100 between the side wall 106 of the housing 100 and the intermediate gear 410 and the intermediate gear 410 is located and mounted in the cavity 112 in the base 102 of the housing 100 between the output gear 414 and the motor pinion 202.

In the embodiment shown, the sensor assembly 300, the motor assembly 200 including the motor pinion 202, the intermediate gear 410, and the output gear 414 are all located and positioned in the cavity 112 of the base 102 in a generally longitudinally extending/horizontal and side-by-side relationship.

Further, in the embodiment shown, the motor pinion 202, the intermediate gear 410, and the output gear 414 are all located and positioned in the cavity 112 of the base 102 in a generally longitudinally extending/horizontal and side-by-side relationship wherein at least the base 206 of the motor pinion 202, the collar 420 of the gear 410, and the gear wheel 440 of the gear 414 are positioned and oriented in a horizontally co-linear, and co-planar relationship. Further, in the embodiment as shown in FIG. 2, the shafts 402, 430, and 449 are all positioned and extend in a co-linear, spaced apart and parallel relationship along the length of the central longitudinal axis of the actuator 10.

Still further, and as shown in FIG. 3, the flange 407 on the motor shaft 402 defines an axial stop that limits not only the axial travel of the motor pinion 202 in the direction of the floor 103 of the housing 100 but also limits the axial travel of the intermediate gear 410 in the direction of the floor 103 of the housing 100 as a result of the gear wheel 416 being abutted against the shoulder 203 on the motor pinion 202; the washer 435 and the retaining ring 437 define an axial end stop that limits not only the axial travel of the intermediate gear 410 in the direction of the cover 114 but also limits the axial travel of both the motor pinion 202 and the output gear 414 in the direction of the cover 114 as a result of the shoulder 203 on the motor pinion 202 being abutted against the gear wheel 416 of the intermediate gear 410 and also as a result of the gear wheel 440 on the output gear 414 being abutted against the shoulder 419 on the intermediate gear 410; and the radial flange 453 on the output gear shaft 449 defines an axial end stop that limits not only the axial travel of the output gear 414 in the direction of the plate 103 of the housing 100 but also limits the axial travel of the intermediate gear 410 in the direction of the plate 103 of the housing 100 as a result of the shoulder 419 on the intermediate gear 410 being abutted against the gear wheel 440 on the output gear 414.

Still further, and as shown in FIG. 3, a cylindrical bushing 600 is located between the exterior surface of the collar 444 of the output gear shaft 449 and the interior surface of the housing sleeve or collar 111.

Additionally, and as also shown in FIG. 3, the gear assembly 400 also includes an interface pinion gear 500 that is located in the sleeve 107 in the floor 103 of the base 102 of the housing 100 in a relationship surrounding the collar 444 of the output gear shaft 449 and is adapted to be coupled and meshed with the shaft of the apparatus or part to be rotated including, for example, the rotatable shaft (not shown) of a vehicle turbocharger assembly (not shown).

During operation, the Hall effect sensor 301 (FIGS. 2 and 3) senses the magnetic field generated by the sensor magnet 211 and provides a signal representative of the position of the motor pinion 202 to the processor which regulates, commutates, or switches the direction of current passing through the appropriate windings (not shown) of the stator assembly 204 of the motor assembly 200 such that each respective column is switched at the right time to become a north or south electromagnet thereof attracting or repelling the motor magnet 210 and causing the motor pinion 202 to rotate.

The rotation of the motor pinion 202 drives and causes the rotation of the intermediate gear 410 coupled thereto which, in turn, drives and causes the rotation of the output gear 414 coupled to the intermediate gear 410 which, in turn, drives and causes the rotation of the output gear shaft 449 which, in turn, causes the rotation of the rotatable shaft of an apparatus or part such as, for example, the rotatable shaft (not shown) of a vehicle turbocharger assembly (not shown).

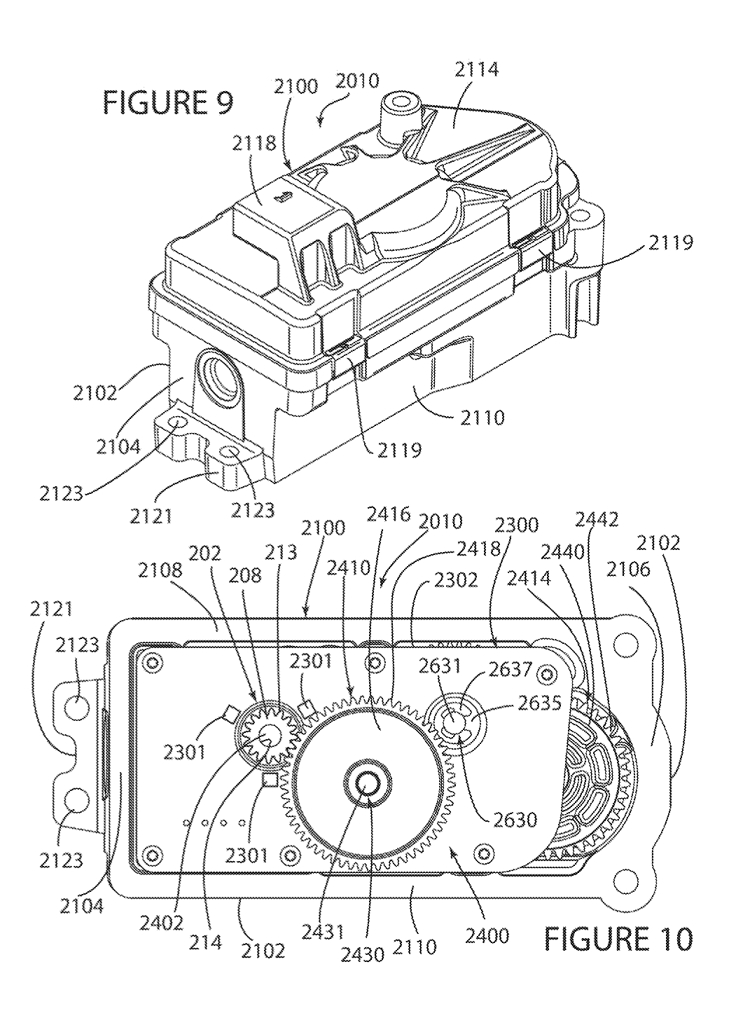

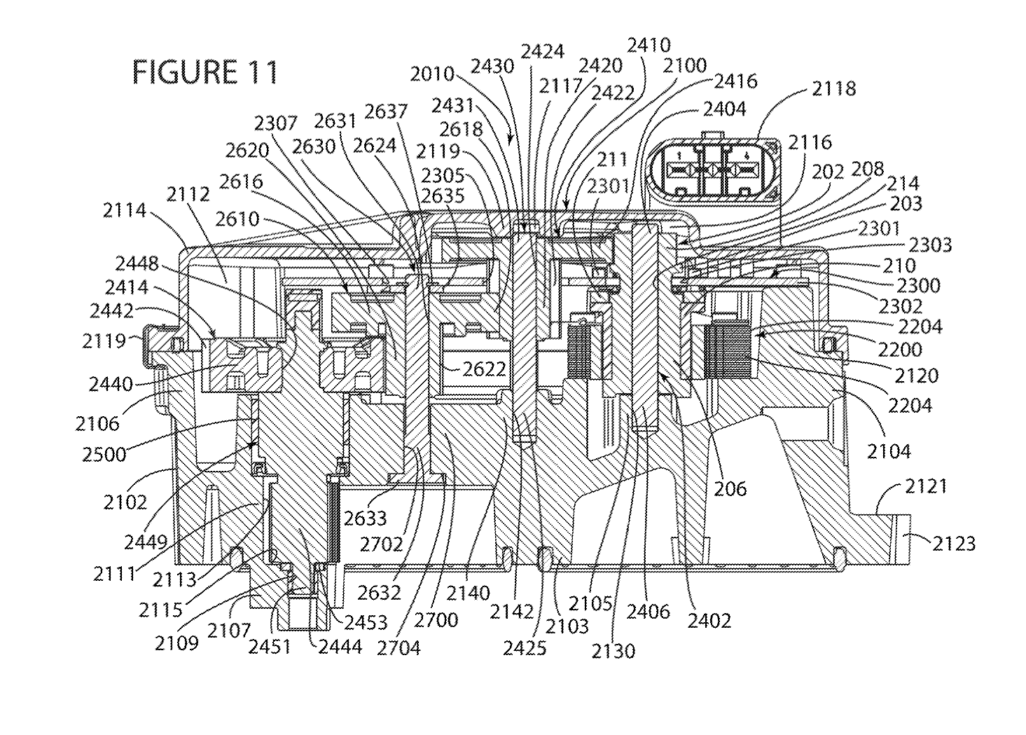

FIGS. 9, 10, and 11 depict another embodiment of a rotary actuator 2010 in accordance with the present invention which comprises a housing 2100 having a motor assembly 2200 (FIG. 11), a circuit board and sensor control assembly 2300 (FIGS. 10 and 11), and a gear assembly 2400 (FIGS. 10 and 11) located and mounted in the housing 2100.

The housing 2100, which in the embodiment shown is generally rectangularly-shaped, includes an elongate generally rectangularly-shaped hollow metal base 2102 with an elongate bottom horizontal plate or floor 2103 (FIG. 11), a pair of longitudinally extending and opposed side walls 2108 and 2110 (FIGS. 9 and 10), and a pair of transversely extending and opposed side walls 2104 and 2106 (FIGS. 10 and 11), all extending unitarily generally normally upwardly from the top peripheral interior edge of the floor 2103 and together with the floor 2103 defining an interior basin or cavity 2112 (FIG. 11) which houses the motor assembly 2200, the circuit board and control assembly 2300, and the gear assembly 2400 of the actuator 2010 as described in more detail below.

A mounting bracket 2121 protrudes generally normally outwardly from a lower edge of the side wall 2104 of the base 2102 of the housing 2100 and defines a pair of through-holes 2123 adapted to receive screws (not shown) for mounting the actuator 2010 to the vehicle.

The housing 2100 still further includes an elongate and generally rectangularly-shaped removable plate or cover 2114 (FIGS. 9 and 11) which may be made of plastic or the like material, is seated over the top peripheral edge of the housing walls 2104, 2106, 2108, and 2110 of the base 2102, and covers the cavity 2112 in the base 2102 of the housing 2100. A plurality of clips 2119 (FIGS. 9 and 11) couple the lower edge of the cover 2114 to the top edge of the housing walls 2106 and 2110 for securing the cover 2114 to the base 2102 of the housing 2100.

As shown in FIGS. 9 and 11, the cover 2114 includes an interior surface defining a pair of generally cylindrically-shaped interior apertures or cavities or recesses 2116 and 2117 adapted to receive the upper end 2404 of the motor shaft 2402 of the motor assembly 2200 and the upper end 2431 of the gear shaft 2430 respectively as described in more detail below. The recess 2117 is defined by a sleeve 2119 on the interior surface of the cover 2114 that protrudes into the interior of the housing 2100.

As further shown in FIGS. 9 and 11, the cover 2114 also includes an electrical terminal connector assembly 2118 extending unitarily outwardly from the outer surface of the cover 2114.

The base 2102 of the housing 2100 includes a plurality of spaced-apart and generally parallel interior printed circuit board/substrate mounting posts or flanges or pedestals 2120 (only one of which is shown in FIG. 11) extending generally normally upwardly and outwardly from the floor 2103 of the base 2102 into the interior of the cavity 2112 of the base 2102 and in the direction of the cover 2114.

The floor 2103 of the base 2102 of the housing 2100 includes a motor shaft sleeve or collar 2105 (FIG. 11) extending generally normally outwardly from the interior surface of the floor 2103 into the cavity 2112 and defining an interior recess or cavity 2130 (FIG. 11) adapted to receive a lower end 2406 of the motor shaft 2402 as described in more detail below.

The floor 2103 of the base 2102 of the housing 2100 further includes an elongate, partially open output shaft sleeve or collar 2107 (FIG. 11) extending generally normally outwardly from the exterior surface of the floor 2103 of the base 2102 of the housing 2100 and defining an interior recess or cavity 2109 (FIG. 11) adapted to receive the lower end 2451 of an output gear shaft 2449 as described in more detail below.

In the embodiment shown, the output gear shaft sleeve or collar 2107 is located in the floor 2103 of the base 2102 adjacent and spaced from the transverse side wall 2106 of the base 2102 of the housing 2100. Also, in the embodiment shown, the output shaft sleeve or collar 2107 defines a seat or shoulder 2115. The motor shaft sleeve or collar 2105 is located in the floor 2103 of the base 2102 of the housing 2100 between the transverse side wall 2104 and the output gear shaft sleeve or collar 2107.

The floor 2103 of the base 2102 of the housing 2100 further includes another output gear sleeve or collar 2111 (FIG. 11) extending generally normally outwardly from the interior surface of the floor 2103 into the cavity 2112 and defining an interior recess or cavity 2113 (FIG. 11) adapted to receive the collar 2444 (FIG. 11) of the output gear shaft 2449 as described in more detail below. The sleeve or collar 2111 is co-axial with the sleeve or collar 2107.

The floor 2103 of the base 2102 of the housing 2100 includes yet another sleeve or collar 2140 (FIG. 11) extending generally normally inwardly from the interior surface of the floor 2103 of the base 2102 of the housing 2100 into the cavity 2112 and defines another interior recess or cavity 2142 (FIG. 11) adapted to receive the lower end 2425 of an intermediate gear shaft 2430 (FIG. 11) as also described in more detail below.

In the embodiment shown, the sleeve or collar 2140 is located in the floor 2103 of the base 2102 of the housing 2100 in a relationship spaced from and between the respective sleeves or collars 2105 and 2107 also in the floor 2103 of the base 2102 of the housing 2100.

The floor 2103 of the base 2102 of the housing 2100 includes yet a further sleeve or collar 2700 (FIG. 11) extending generally normally inwardly from the interior surface of the floor 2103 of the base 2102 of the housing 2100 into the cavity 2112 and defines another interior recess or cavity 2702 (FIG. 11) defining an interior shoulder 2704 adapted to receive the lower end 2632 of another intermediate gear shaft 2630 as also described in more detail below. The sleeve or collar 2700 is located in the floor 2103 of the base 2102 of the housing 2100 in a relationship spaced from and between the collars 2111 and 2140.

The actuator 2010 further comprises the motor assembly 2200 (FIG. 11) that includes a stationary stator assembly 2204 and a rotor in the form of the rotatable motor pinion 202 as described earlier with respect to the actuator 10, and thus the earlier description of the elements and features of the motor pinion 202 are incorporation herein by reference.

An elongate stationary motor shaft 2402 is located and mounted in the cavity 2112 of the base 2102 of the housing 2100 in a generally vertical and normal relationship relative to the floor 2103 of the base 2102 and the cover 2114 of the housing 2100 wherein a first upper end 2404 of the motor shaft 2402 extends into the aperture 2116 defined in the interior surface of the cover 2114 of the housing 2100 and a lower end 2406 of the motor shaft 2402 is secured in the recess 2130 defined in the sleeve 2107 in the floor 2103 of the base 2102 of the housing 2100.

As shown in FIG. 3, the lower end 406 of the motor shaft 402 includes a horizontal radial flange 407 that extends generally normally outwardly from the exterior surface thereof and is seated against the interior surface of the floor 103 of the base 102 of the housing 100 and defines an axial end stop that abuts against the lower surface of the base 206 of the flange 205 of the motor pinion 202 and limits the travel of the motor pinion 202 in the direction of the floor 103 of the base 102 of the housing 100.

As shown in FIG. 11, the motor pinion 202 is located in the cavity 2112 in the base 2102 of the housing 2100 in a relationship surrounding and rotatable relative to the stationary motor shaft 2402 and in a relationship wherein the lower surface of the base 206 of the motor pinion 202 is abutted and seated against an upper edge of the sleeve 2105 and defines an axial end stop that limits the travel of the motor pinion 202 in the direction of the floor 2103 of the base 2102 of the housing 2100.

The motor assembly 2200 further includes a stationary stator assembly 2204 (FIG. 11) which is also located and mounted in the cavity 2112 in the base 2102 of the housing 2100 in a relationship surrounding and spaced from the motor pinion 202.

The actuator 2010 still further comprises a circuit board and control assembly 2300 (FIGS. 10 and 11) that includes a plurality of elements including, for example, a plurality of magnetic field sensors 2301 such as Hall effect sensors, a processor or controller, and other passive and active electronic components (not shown) that are mounted on one or both sides of a generally flat printed circuit board or substrate 2302 that is located and mounted in the cavity 2112 in the base 2102 of the housing 2100 in a horizontal relationship and that is seated against the top surface of the interior mounting posts or pedestals 2120.

Thus, in the embodiment shown, the printed circuit board or substrate 2302 is located in the cavity 2112 in the base 2102 of the housing 100 in a suspended horizontal and parallel relationship between and spaced from the floor 2103 of the base 2102 and the cover 2114 and, more specifically, is located between the stator assembly 2204 and the cover 2114. In the embodiment shown, the base 206 of the motor pinion 202 is located below the substrate 2302; the collar 208 of the motor pinion 202 extends through an opening 2303 in the substrate 2302, and the top surface of the ring shaped sensor magnet 211 on the motor pinion 202 is located below the substrate 2302 and spaced from and generally opposite and parallel to the Hall effect sensors 2301 on the substrate 2302.

In the embodiment shown, three Hall effect sensors 2301 are located on the top surface of the substrate 2302 and extend circumferentially around the opening 2303 in the substrate 2302 in a spaced apart relationship. Thus, the Hall effect sensors 2301 also extend circumferentially around the motor pinion shaft 2402 and the collar 208 of the motor pinion 202 that both extend through the opening 2303 in the substrate 2302. In the embodiment shown, the three Hall sensors 2301 are spaced one hundred and twenty degrees from each other.

A plurality of stator terminals, not shown but similar to the terminals 600 shown in FIG. 3, extend between the stator assembly 2204 and upwardly into and through the board 2302 while connector terminals (not shown) extend downwardly into the end of the board 2302 for electrically interconnecting together the motor assembly 2200, the board 2302, and the connector assembly 2118.

As shown in FIGS. 10 and 11, the gear assembly 2400 of the actuator 2010 includes first, second, and third rotatable gears in the form of a pair of rotatable intermediate gears 2410 and 2610 and an output gear 2414 which are all located and mounted in the cavity 2112 in the base 2102 of the housing 100 and are coupled to each other and to the motor pinion 202 for rotation as described in more detail below.

The intermediate gear 2410 is preferably made of plastic or the like material and includes a rotatable gear wheel 2416 with peripheral and circumferentially extending gear teeth 2418 (FIG. 10) formed thereon and an elongate rotatable collar 2420 (FIG. 11) extending unitarily downwardly and normally outwardly and centrally from the lower surface of the gear wheel 2416 and including an outer surface with a plurality of gear teeth 2422 (FIG. 11) formed thereon. In the embodiment shown, the gear wheel 2416 is located above, spaced from, and generally parallel to, the substrate 2302 and the collar 2420 extends through an opening 2305 in the substrate 2302.

The intermediate gear 2410 additionally defines a through-aperture 2424 (FIG. 11) extending centrally through the interior of the collar 2420 and the gear wheel 2416.

The gear assembly 2400 also includes an elongate stationary gear shaft 2430 (FIGS. 10 and 11) extending through the intermediate gear 2410 and, more specifically, through the central through-aperture 2424 defined therein in a relationship generally normal to the floor 2103 and the cover 2114 of the housing 2100.

The gear shaft 2430 includes a lower end 2425 (FIG. 11) and an upper end 2431.

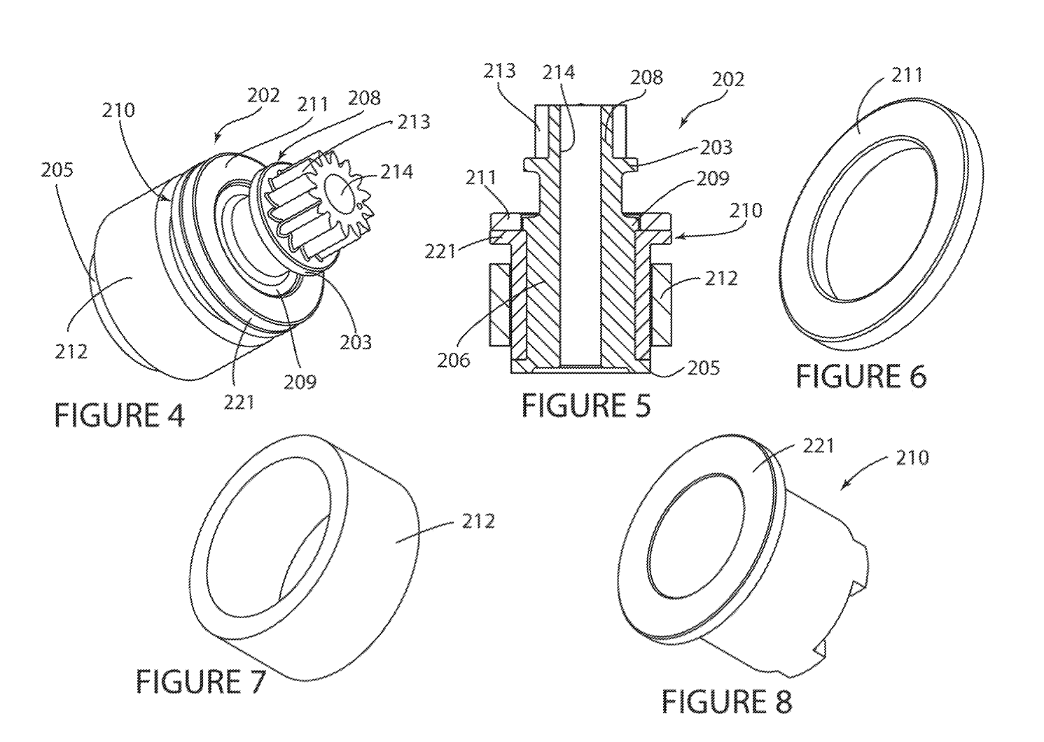

The intermediate gear 2410 and the gear shaft 2430 are located and mounted in the cavity 2112 in the base 2102 of the housing 2100 in a relationship wherein the upper end 2437 of the gear shaft 2430 extends through the opening 2305 in the substrate 2302 and into the recess 2117 in the cover 2114 of the housing 2100; the lower end 2425 of the gear shaft 2430 is received and secured in the recess 2142 defined in the floor 2103 of the base 2102 of the housing 2100; the gear 2410 is rotatable relative to the gear shaft 2430; the gear wheel 2416 of the intermediate gear 2410 is positioned in a relationship opposed, spaced from, and generally parallel to the cover 2114 of the housing 2100; and the gear teeth 2418 on the gear wheel 2416 are disposed in a relationship coupled and meshed to the gear teeth 213 (FIG. 4) on the collar 208 of the motor pinion 202 of the motor assembly 2200 and further in a relationship abutted against the top of the flange 203 on the motor pinion 202 and thus also defining an axial end stop that limits the axial travel of the gear 2410 in the direction of the floor 2103 of the base 2102 of the housing 2100.

The rotatable intermediate gear 2610 is preferably made of plastic or the like material and includes a rotatable gear wheel 2616 with peripheral and circumferentially extending gear teeth 2618 (FIG. 11) formed thereon and an elongate collar 2620 (FIG. 11) extending unitarily downwardly and normally outwardly and centrally from the lower surface of the gear wheel 2616 and including an outer surface with a plurality of gear teeth 2622 (FIG. 11) formed thereon. In the embodiment shown, the gear wheel 2016 is located below, and spaced from, and generally parallel to the substrate 2302.

The intermediate gear 2610 additionally defines a through-aperture 2624 (FIG. 11) extending centrally through the interior of the rotatable collar 2620 and the gear wheel 2616.

The gear assembly 2400 also includes an elongate stationary gear I-shaft 2630 (FIGS. 10 and 11) extending through the intermediate gear 2610 and, more specifically, through the central through-aperture 2624 defined therein in a relationship normal to the floor 2103 and the cover 2114 of the housing 2100.

The I-shaft 2630 includes a lower end 2632 (FIG. 11) and an upper end 2631 that extends through an opening 2307 in the substrate 2302. The lower end 2632 includes a horizontal radial flange 2633 (FIG. 11) extending generally normally outwardly from the exterior surface thereof. A washer 2635 surrounds the upper end 2631 of the I-shaft 2630 and is seated against the top surface of the gear wheel 2616 of the intermediate gear 2610. A retaining ring 2637 also surrounds the upper end 2631 of the I-shaft 2630 and is seated against the top surface of the washer 2635.

The intermediate gear 2610 and the I-shaft 2630 are located and mounted in the cavity 2112 in the base 2102 of the housing 2100 in a relationship wherein the upper end 2637 of the I-shaft 2630 protrudes through the opening 2307 in the substrate 2302; the lower end 2632 of the I-shaft 2630 is received and secured in the recess 2702 defined in the floor 2103 of the base 2102 of the housing 2100 and, more specifically, in a relationship wherein the radial flange 2633 on the lower end 2632 of the I-shaft 2630 is abutted against the shoulder 2704 defined in the floor 2103 of the base 2102 of the housing 2100 and defining an axial end stop that limits the axial travel of the gear 2610 in the direction of the floor 2103 of the base 2102 of the housing 2100; the washer 2635 holds the intermediate gear 2610 on the gear I-shaft 2630; the retaining ring 2637 retains the washer 2635 and the gear 2616 on the gear I-shaft 2630 and defines an axial end stop that limits the axial travel of the gear 2630 in the direction of the cover 2114; the gear 2610 is rotatable relative to the I-shaft 2630; the gear wheel 2616 of the intermediate gear 2610 is positioned in a relationship opposed, spaced from, generally parallel, and below the substrate 2302; and the gear teeth 2618 on the gear wheel 2616 are disposed in a relationship coupled and meshed to the gear teeth 2422 on the collar 2420 of the intermediate gear 2410.

The output gear 2414, which is also preferably made of plastic or the like material, includes a rotatable gear wheel 2440 (FIGS. 10 and 11) with peripheral and circumferentially extending gear teeth 2442 formed thereon and a separate elongate rotatable gear shaft 2449 (FIG. 11) extending downwardly and normally outwardly and centrally from the bottom surface of the gear wheel 2440 in a relationship normal to the floor 2103 and the cover 2114 of the housing 2100 and including an upper end extending through a central through-hole 2448 (FIG. 11) defined in the gear wheel 2440. In the embodiment shown, the gear wheel 2440 is located in the housing 2100 in a relationship below, spaced from, and generally parallel to, the gear wheel 2620.

The output gear shaft 2449 includes a lower end 2451 (FIG. 11) defining a horizontal radial shoulder 2453 (FIG. 11) defining an axial end stop.

The output gear 2414 and the output gear shaft 2449 are located and mounted in the housing 2100 between the floor 2103 of the housing 2100 and the substrate 2302 in a relationship wherein: the collar 2444 of the output gear shaft 2449 extends through the sleeves 2111 and 2107 in the floor 2103 of the base 2102 of the housing 2100; the lower end 2451 of the output gear shaft 2449 is received in the recess 2109 defined in the sleeve 2107 in the floor 2103 of the base 2102 of the housing 2100 and the radial shoulder 2453 on the lower end 2451 of the output gear shaft 2449 is seated against the top of the sleeve shoulder 2115 and defines an axial end stop for the output gear 2414 that limits the axial travel of the output gear 2414 in the direction of the floor 2103 of the base 2102; the output gear 2414 is rotatable with the output gear shaft 2449; the gear wheel 2440 is positioned in a relationship opposed, abutting against, and generally parallel to, a lower surface of the gear wheel 2616 of the intermediate gear 2610; and the gear teeth 2442 on the gear wheel 2440 are disposed in a relationship coupled and meshed to the gear teeth 2622 on the collar 2620 of the intermediate gear 2610.

Thus, in the embodiment shown, the output gear 2414 is located and mounted in the cavity 2112 in the base 2102 of the housing 2100 between the side wall 2106 of the housing 2100 and the intermediate gear 2610; the intermediate gear 2610 is located and mounted in the cavity 2112 in the base 2102 of the housing 2100 between the output gear 2414 and the intermediate gear 2410; the intermediate gear 2410 is located between the intermediate gear 2610 and the motor pinion 202; and the motor pinion 202 is located between the intermediate gear 2410 and the transverse housing side wall 2104.

In the embodiment shown, the motor assembly 2200 including the motor pinion 202, the intermediate gear 2410, the intermediate gear 2610, and the output gear 2414 are all located and positioned in the cavity 2112 of the base 102 in a generally longitudinally extending/horizontal and side-by-side relationship.

Further, in the embodiment shown, the motor pinion 202, the intermediate gear 2410, the intermediate gear 2610, and the output gear 2414 are all located and positioned in the cavity 2112 of the base 2102 in a generally longitudinally extending/horizontal, and side-by-side relationship wherein at least the base 206 of the motor pinion 202, the collar 2420 of the gear 2410, the gear wheel 2616 of the gear 2610, and the shaft 2449 of the gear 2414 are positioned and oriented in a horizontally co-linear and co-planar relationship and: the top peripheral edge of the sleeve 2105 defines an axial end stop that limits the axial travel of the motor pinion 202 in the direction of the floor 2103 of the base 2102 of the housing 2100; the upper surface of the flange 203 of the motor pinion 202 is in abutting relationship with the lower surface of the gear wheel 2416 of the intermediate gear 2410 and defines an axial end stop that limits the axial travel of the motor pinion 202 in the direction of the cover 2114; the bottom peripheral edge of the sleeve 2119 defined in the interior surface of the cover 2114 defines an axial end stop that limits the axial travel of the gear wheel 2416 abutted against the sleeve 2119 and the flange 203 of the motor pinion 222 defined an axial end stop that limits the axial travel of the gear wheel 2416 in the direction of the floor 2103 of the base 2102 of the housing 2100; the combination of the washer 2635 and retaining ring 2637 on the gear shaft 2630 defines an axial end stop that limits the axial travel of the gear wheel 2616 in the direction of the cover 2114 and the gear wheel 2440 of the output gear 2414 defines an axial end stop that limits the axial travel of the gear wheel 2616 in the direction of the floor 2103 of the base 2102 of the housing 2100 by virtue of its abutment against the gear wheel 2440 of the output gear 2414; and the shoulder 2115 of the sleeve 2107 in the floor 2103 of the base 2102 of the housing 2100 defines an axial end stop that limits the axial travel of the output gear shaft 2449 that includes a lower end 2444 in abutment with the shoulder 2115 in the direction of the floor 2103 of the base 2102 of the housing 2100, and the gear wheel 2616 of the intermediate gear 2610 defines an axial end stop that limits the axial travel of both the output gear shaft 2449 and the output gear wheel 2440 that is in abutting relationship with the gear wheel 2616 in the direction of the cover 2114.

Still further, and as shown in FIG. 11, a cylindrical bushing 2500 is located between the exterior surface of the output gear shaft 2449 and the interior surface of the housing sleeve or collar 2111 and the sensor 2311 is located on an upper/lower surface of the substrate 2302 in a relationship spaced from and opposed to the sensor magnet 211 on the motor pinion 202.

During operation, the Hall effect sensor 2311 (FIGS. 10 and 11) senses the magnetic field generated by the sensor magnet 211 and provides a signal representative of the position of the motor pinion 202 to the processor which regulates, commutates, or switches the direction of current passing through the appropriate windings (not shown) of the stator assembly 2204 of the motor assembly 2200 such that each respective column is switched at the right time to become a north or south electromagnet thereof attracting or repelling the motor magnet 210 and causing the motor pinion 202 to rotate.

The rotation of the motor pinion 202 drives and causes the rotation of the intermediate gear 2410 coupled thereto which, in turn, drives and causes the rotation of the intermediate gear 2610 coupled to the intermediate gear 2410 which, in turn, drives and causes the rotation of the output gear 2414 coupled to the output gear 2610 which, in turn, causes the rotation of the output gear shaft 2449 which, in turn, causes the rotation of the rotatable shaft of an apparatus or part such as, for example, the rotatable shaft (not shown) of a vehicle turbocharger assembly (not shown).

Numerous variations and modifications of the embodiments described above may be effected without departing from the spirit and scope of the novel features of the invention. It is thus understood that no limitations with respect to the actuators illustrated herein are intended or should be inferred. It is, of course, intended to cover by the appended claims all such modifications as fall within the scope of the claims.

I claim:

1. An actuator comprising:
a housing;
a motor assembly in the housing, the motor assembly including a rotatable motor pinion and a stator surrounding and spaced from the motor pinion;
a gear assembly in the housing including a first rotatable gear coupled to the motor pinion and a second rotatable gear adapted for rotation in response to the rotation of the motor pinion and the first rotatable gear; the motor pinion and the first and second gears being positioned in a generally horizontally co-linear, and side-by-side relationship; and
a sensor assembly including a substrate in the housing.

2. The actuator of claim 1 wherein the motor pinion includes a collar with gear teeth, and each of the first and second gears includes a gear wheel with gear teeth and a collar with gear teeth, the gear teeth on the collar of the motor pinion being coupled to the gear teeth on the gear wheel of the first gear, and the gear teeth on the collar of the first gear being coupled to the gear teeth on the gear wheel of the second gear.

3. The actuator of claim 1 wherein the motor pinion is mounted for rotation on a motor pinion shaft and each of the first and the second gears is mounted for rotation on first and second gear shafts respectively, the motor pinion gear shaft and the second gear shaft including an end with a radial flange defining an axial end stop for the motor pinion and the second gear respectively.

4. The actuator of claim 3 wherein the first gear shaft includes a lower end with a radial flange which is secured in a base of the housing and an upper end including a washer and a retaining ring coupled thereto for retaining the first gear on the first gear shaft and defining an axial end stop for the first gear.

5. The actuator of claim 1 wherein the substrate is suspended in the housing between the stator of the motor assembly and a cover of the housing.

6. The actuator of claim 1 wherein the motor pinion includes a motor magnet, a sensor magnet, and a yoke.

7. The actuator of claim 6 wherein the motor pinion includes a base, the yoke surrounding the base, the motor magnet surrounding the yoke, and the sensor magnet is located above the yoke and the motor magnet.

8. The actuator of claim 1 wherein the gear assembly includes a third rotatable gear coupled between the first and second gears.

9. The actuator of claim 8 wherein the motor pinion includes a collar with gear teeth, and each of the first, second, and third gears includes a gear wheel with gear teeth and a collar with gear teeth, the gear teeth on the collar of the motor pinion being coupled to the gear teeth on the gear wheel of the first gear, the gear teeth on the collar of the first gear being coupled to the gear teeth on the gear wheel of the third gear, and the gear teeth on the collar of the third gear being coupled to the gear teeth on the gear wheel of the second gear.

10. The actuator of claim 9 wherein the motor pinion is mounted for rotation on a motor pinion shaft and each of the first, second, and third gears is mounted for rotation on first, second, and third gear shafts respectively.

11. An actuator comprising:
a housing;
a motor assembly including a rotatable motor pinion and a stator located and mounted in the housing, the motor pinion including a base, a yoke surrounding the base, a motor magnet surrounding the yoke, and a sensor magnet located above the base;
a gear assembly in the housing including a plurality of gears adapted for rotation in response to the rotation of the motor pinion;
a sensor assembly including a substrate suspended in the housing in a relationship spaced and opposed to the sensor magnet on the motor pinion of the motor assembly.

12. The actuator of claim 11 wherein the motor magnet and the sensor magnet are ring-shaped and the yoke is in the form of a tube.

13. The actuator of claim 12 wherein the yoke includes a flange and the sensor magnet is seated on the flange of the yoke.

14. The actuator of claim 11 wherein the motor pinion and the plurality of gears are located in the housing in a longitudinal, co-linear, and side-by-side relationship.

15. An actuator comprising:
a housing including a base defining an interior cavity and a cover;
a motor assembly including a rotatable motor pinion located and mounted in the cavity in the base of the housing;
a gear assembly including first and second gears located and mounted in the cavity in the base of the housing, the first gear being coupled to the motor pinion for rotation therewith and the second gear being coupled to the first gear for rotation therewith;
first, second, and third shafts located and mounted in the cavity in the base of the housing, the first and second gears and the motor pinion being mounted for rotation on the first, second, and third shafts respectively, the first and third shafts each including a stop that limits the axial travel of the motor pinion and the first and second gears respectively in the direction of the base of the housing, the first shaft including a stop that limits the axial travel of the motor pinion and the first and second gears in the direction of the cover; and
a sensor assembly including a substrate located in the cavity in the base of the housing.

16. The actuator of claim 15, wherein the motor pinion and the first gear each include a shoulder and the first and second gears each include a gear wheel, the gear wheel on the second gear abutting against the shoulder on the first gear and the gear wheel on the first gear abutting against the shoulder on the motor pinion.

17. The actuator of claim 16, wherein the stop on each of the first and third shafts is a radial flange on a lower end of the first and third shafts respectively and the stop on the first shaft includes a washer and a retaining ring on an upper end of the first shaft.
